(19) United States
(12) Patent Application Publication
(10) Pub. No.: US 2020/0404122 A1
(43) Pub. Date: Dec. 24, 2020

(54) IMAGE SCANNING APPARATUS FOR PROTECTING PERSONAL INFORMATION AND METHOD FOR SCANNING IMAGE THEREOF

(71) Applicant: Hewlett-Packard Development Company, L.P., Spring, TX (US)

(72) Inventor: Jang Geun KIM, Seongnam-si (KR)

(21) Appl. No.: 16/979,287

(22) PCT Filed: Jul. 30, 2018
(86) PCT No.: PCT/KR2018/008635

§ 371 Date: Sep. 9, 2020

(30) Foreign Application Priority Data
Apr. 11, 2018 (KR) 10-2018-0042204

(51) Int. Cl. H04N 1/44; H04N 1/32; H04N 1/00

(52) U.S. Cl. CPC H04N 1/4493; H04N 1/0044; H04N 1/32272; H04N 1/4446

(57) ABSTRACT

An image scanning apparatus and method for protecting personal information are provided. The image scanning apparatus may include an image sensor which scans a manuscript, a memory, and a processor to generate a scan image using a signal that is output from the image sensor, perform a masking process for personal information included in the generated scan image, generate scan data that includes additional information for recovering the masked personal information and the masked scan image, and store the same in the memory.

### BACKGROUND ART

An image scanning apparatus refers to a device that scans original images from documents, pictures, film, or the like and converts them into digital data as an output image. In this case, the digital data produced as the output image may be displayed on a computer monitor or printed by a printer. Examples of the image scanning apparatus may include a scanner, a copy machine, a facsimile, or a multi-function printer (MFP) implementing functions of the above.

### DISCLOSURE OF INVENTION

### Brief Description of Drawings

The above and/or other aspects, features, and advantages of certain examples of the disclosure will be more apparent from the following description taken in conjunction with the accompanying drawings, in which:

FIG. 1 is a block diagram illustrating a brief configuration of an image scanning apparatus according to an example;

FIG. 2 is a block diagram illustrating a more detailed configuration of an image scanning apparatus according to an example;

FIG. 3 is a diagram illustrating a form of an image scanning apparatus, such as the image scanning apparatus of FIG. 1, according to an example;

FIGS. 4 to 7 are views illustrating various user interface windows which can be displayed according to examples;

FIGS. 8 to 10 are views to describe additional information included in scan data according to examples;

FIG. 11 is a flowchart of an image scanning method according to an example; and

FIG. 12 is a flowchart of an image scanning method using an option setting state according to an example.

Throughout the drawings, it should be noted that like reference numbers are used to depict the same or similar elements, features, parts, components, and structures.

### MODE FOR THE INVENTION

Various examples now will be described more fully hereinafter with reference to the accompanying drawings. The examples described hereinafter may be modified in many different forms. To more clearly describe features of examples, matters well known to one of ordinary skill in the art to which the below examples pertain will not be described in detail.

The matters defined in the description, such as construction and elements, are provided to assist in a comprehensive understanding of the present inventive concept. Accordingly, it is apparent that the examples of the present inventive concept can be carried out without those specifically defined matters.

When the specification states that one constituent element is “connected to” another constituent element, it includes a case in which the two constituent elements are “connected to each other with another constituent element intervened therebetween” as well as a case in which the two constituent elements are “directly connected to each other.” Further, when one constituent element “comprises (or includes)” another constituent element, unless specifically stated to the contrary, other constituent elements may be further included rather than precluding the same.

The expression “image forming job” as used herein may refer to various jobs related with an image, such as formation of an image or generation/storage/transmission of image files (e.g., printing, scanning, copying, faxing, or the like), and the expression “job” as used herein may refer to not only the image forming job, but also a series of processes required for performance of the image forming job.

Further, the expression “image scanning apparatus” as used herein may refer to an apparatus that scans an image of the document and generates a scan image. Examples of an image scanning apparatus may include a scanner, a copy machine, a facsimile, or a multi-function printer (MFP) implementing functions of the above. Meanwhile, when the image scanning apparatus is a copy machine, a facsimile, a multi-function printer or the like, which are capable of the image forming job, the image scanning apparatus may also be referred to as the image forming apparatus.

Further, the expression “image forming apparatus” as used herein refers to an apparatus that prints the printing data generated at a terminal such as a computer onto a recording medium. Examples of an image forming apparatus may include a copy machine, a printer, a facsimile, or a multi-function printer (MFP) implementing functions of the above. The printer, the scanner, the fax machine, the multi-function printer (MFP), a display apparatus, or the like may represent any apparatus that can perform the image forming job.

Further, the expression “hard copy” as used herein may refer to an operation of outputting an image to a recording medium such as paper, and the expression “soft copy” as used herein may refer to an operation of outputting an image to a display device such as a TV, a monitor, or the like, or to a memory.

Further, the expression “content” as used herein may refer to any type of data as a subject of the image forming job, such as a picture, an image, a document file, or the like.

Further, the expression “printing data” as used herein may refer to data converted into a format that can be printed at the printer. Meanwhile, when the printer supports direct printing, the file itself may be the printing data.

Further, the expression “scanned data” as used herein may refer to a scan image generated at the scanner, may be a black and white image, a color image, or the like, and may have various forms of file formats (e.g., BMP, JPG, TIFF, PDF, or the like).

Further, the expression “main scanning direction” as used herein may refer to a scanning direction of the scanner, and specifically, it may refer to a direction perpendicular to a moving direction of a printing document.

Further, the expression “sub scanning direction” may refer to a moving direction of a document.

Further, the expression “user” as used herein may refer to a person who performs a manipulation related with the image forming job using the image scanning apparatus or a device connected to the image scanning apparatus in a wired or wireless fashion. Further, the expression “manager” as used herein may refer to a person who has an authority to access all the functions and systems of the image scanning apparatus. The “manager” and the “user” may refer to the same person.

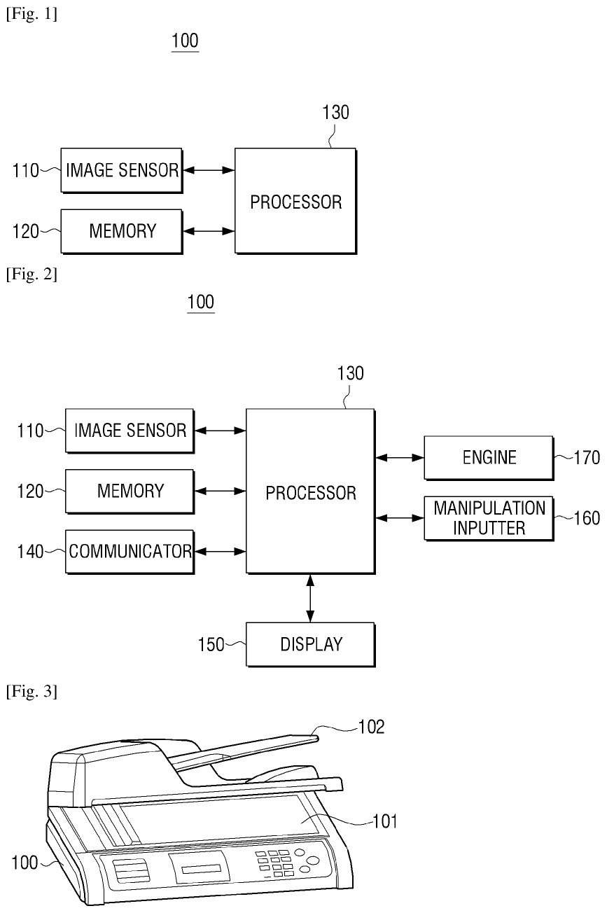

FIG. 1 is a block diagram illustrating a brief configuration of an image scanning apparatus according to an example.

Referring to FIG. 1, an image scanning apparatus 100 may include an image sensor 110, a memory 120, and a processor 130.

The image sensor 110 may scan a document. For example, the image sensor 110 may scan image information of a document from the light reflected from the document. The image sensor 110 may include a charge coupled device (CCD) disposed in a row along the main scanning direction or a plurality of CMOS image sensors (CIS). The image sensor 110 may be disposed on a lower end of a flatbed and disposed within an automatic document feeder (ADF).

The image sensor 110 may include a conversion circuit that converts a scanned signal into a digital signal. For example, the CCD and the digital CIS may output a scanned signal in a digital signal form, while the CIS may output a scanned signal in an analog signal form. Accordingly, when the image sensor 110 includes the CIS, it may convert a scanned signal into a digital signal using the conversion circuit and output the converted digital signal to the processor 130.

The memory 120 may store data for image processing. In particular, the memory 120 may store a program required to perform image processing of the processor 130, or may store data read from the image sensor 110 or processed by the processor 130.

The memory 120 may store a scan image generated by the processor 130 and may store scan data in which personal information is masked. The memory 120 may be implemented as a storage medium in the image scanning apparatus 100 or as an external storage medium such as a removable disk including a universal serial bus (USB) memory, a storage medium connected to a host, a web server via a network, or the like.

The processor 130 may control each constituent element within the image scanning apparatus 100. For example, the processor 130 may be implemented as a central processing unit (CPU), an application specific integrated circuit (ASIC), or the like, and sense whether a scan command is inputted from a user. In an example, a scan command may be inputted through a manipulation inputter provided on the image scanning apparatus 100 or through a communicator as a signal from an external device (for example, a personal computer (PC), a smartphone, or the like).

The processor 130 generates a scan image using a signal output from the image sensor 110. The processor 130 may store the generated scan image in the memory 120 or a predetermined storage address. The processor 130 may encrypt the scan image with a preset key and store the encrypted scan image in the memory 120 or a predetermined storage address. Herein, the preset key may be a user ID or the like, or may be personal information detected in a process such as that described below. Personal information may be a resident registration number, a phone number, address, email address, job title, company name, etc.

The processor 130 may perform image processing on the generated scan image. Image processing may include adjusting a brightness of the scan image, removing a shadow included in the scan image, or the like.

The processor 130 determines whether masking of personal information is necessary. For example, the processor 130 can determine whether a personal information protection option is set as an option of a user's scanning instruction, or whether a privacy protection option is set as a default option.

The processor 130 may mask personal information included in the generated scan image. For example, when it is determined that masking of personal information is required, the processor 130 may perform optical character recognition (OCR) on the scan image and determine whether personal information exists using the character recognition result.

For example, if keywords related to personal information (e.g., TEL, MOBILE, Email, resident number, “.com”, “/co.kr”, “Seoul,” etc.) are detected, or a number text (For example, xxxxxx-xxxxxxx, xxx-xxxx-xxxx) or character text of a predetermined type is detected, it can be determined that personal information may exist.

In addition, the processor 130 can determine the type of a manuscript based on the layout of the currently generated scan image and determine whether the personal information is included based on the type of the manuscript. For example, a resident registration card, a driver's license, a passport, etc. have a regular layout or a copy protection pattern (or a hologram). In this regard, the processor 130 determines the type of the manuscript based on the layout of the generated scan image or the presence or absence of the copy protection pattern (or the hologram). If the type of the manuscript is a resident registration card, a driver's license, or a passport, it can be confirmed that personal information is included. In the present description, only the resident registration card, the driver's license, and the passport are exemplified, but the present disclosure can be applied to various manuscripts such as business cards, credit cards, or the like that include personal information and have a standardized layout.

If the personal information is included, the processor 130 sets a masking area that can hide all or a part of the personal information included in the scan image. At this time, the processor 130 can determine a type of personal information and set the masking area in a manner corresponding to the confirmed personal information. For example, the entire phone number may be set as the masking area for the telephone number, and in the case of the resident registration number, only a part of the resident registration number may be set as the masking area.

As another example, when the user sets, in advance, protection for only the resident registration number, the processor 130 can set the masking area only for the resident registration number, without setting the masking area for the telephone number.

The processor 130 may perform a masking process for the set masking area. Here, the masking process may be image processing such as overwriting the set masking area with a predetermined color (e.g., black and white), processing a mosaic for the area, replacing the area with a predetermined image, or the like. At the time of implementation, the masking process may be performed in a manner other than the above-described manner.

In addition, the processor 130 may perform different masking processes according to the types of personal information. For example, a mosaic process may be performed on the telephone number, and a process of covering the resident registration number with black may be performed.

If personal information is not included or it appears that a masking process for personal information is not deemed necessary, the processor 130 may store the scan image in the memory 120 as the scanned data.

If masking of personal information is necessary, and personal information is included in the scan image, the processor 130 generates additional information. Here, the additional information may be a generated scan image, a partial image corresponding to the masked area, text information corresponding to the masked area, a storage address of the generated scan image, or the like.

Thus, if the additional information is a partial image, the processor 130 may extract the masking area to generate the partial image. If the additional information is text information, the processor 130 may generate information on the OCR result, a text font, a size, or the like representing the personal information of the scan image as text information or generate the vectorized information on the text in the masked area into text. Here, the vectorized information is information that defines a symbol constituting a text as a straight line or a curved line.

The processor 130 may generate additional information to recover masked personal information and scan data including the scan image which is masked and store the same in the memory 120.

The processor 130 may encrypt the generated scan data, store the encrypted data in the memory 120, or transmit the encrypted data to a storage (e.g., FTP server, e-mail, etc.) set by the user. For example, the processor 130 may perform the encryption process using the personal information included in the scan image. As an example, when a resident registration number is included in a scan image, the scan data can be encrypted using a resident registration number.

Also, the processor 130 may perform an encryption process on the additional information included in the scan data and generate scan data using the encrypted additional information and the masked scan image.

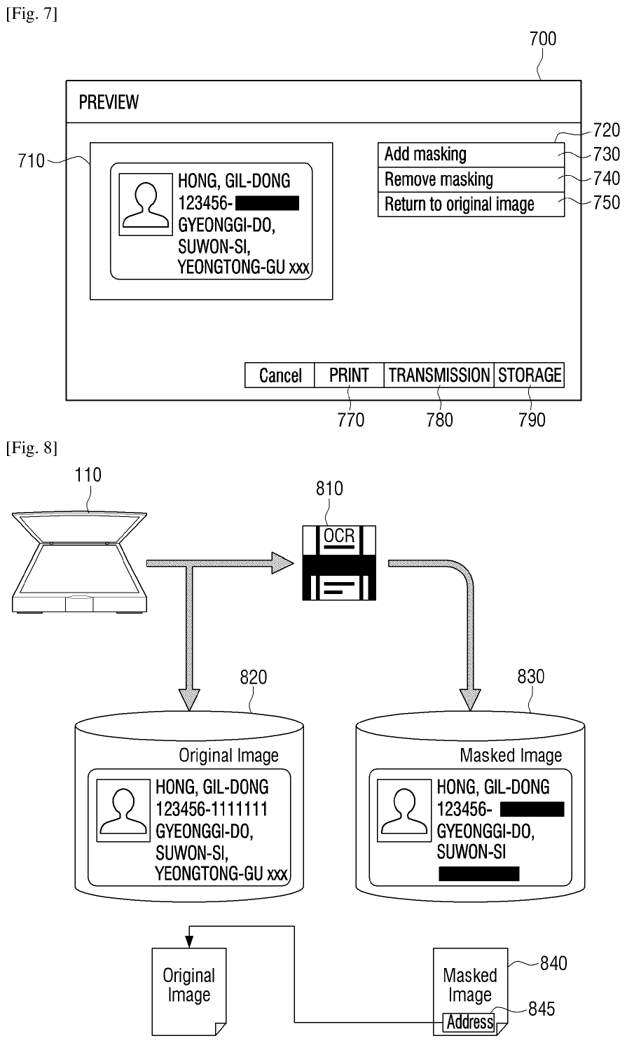

The processor 130 may control to display a preview image corresponding to the masked scan image. At this time, the processor 130 may generate a user interface window including a first area for displaying a preview image corresponding to the masking process, a second area for receiving an option related to the masking process, and control to display the generated user interface window. An example of a user interface window will be described later with reference to FIG. 7.

When the processor 130 receives an instruction to recover to an original image corresponding to a masked scan image, the processor may generate the recovered image using the additional information included in the scan data.

For example, when the additional information includes the scan image itself, the processor 130 can use the scan image included in the additional information as a recovered image. Similarly, if the additional information includes a storage address, the processor 130 may receive the scan image using the storage address and use the received scan image as the recovered image.

If a part of the scan image which corresponds to personal information is included in the additional information, the processor 130 may replace or insert a partial image to a masking area within the masked scan image to recover the image.

Alternatively, when text information is included in the additional information (for example, a text corresponding to the personal information, a font of the text, a size of the text, etc.), the processor 130 may generate a rendering image using the additional information and replace the masked area in the masked scan image with the generated rendering image to recover the scan image.

When a password is set in the scan data or the password is set in the additional information included in the scan data, the processor 130 may request and receive an input of a password from the user, and perform decoding using the input password. At this time, the processor 130 may control to display information on the type of personal information used for encryption.

When the image scanning apparatus 100 includes an automatic paper feeder capable of continuously scanning a plurality of transcripts, the image scanning apparatus 100 may perform a personal information masking process for each of the plurality of scan images and generate a plurality of masked images as one scan data.

An example of a simple configuration of an image scanning apparatus has been shown and described above. However, various configurations may be additionally provided at the time of implementation. Examples of such configurations will be described below with reference to FIG. 2.

FIG. 2 is a block diagram illustrating a more detailed configuration of an image scanning apparatus according to an example.

Referring to FIG. 2, the image scanning apparatus 100 may include the image sensor 110, the memory 120, the processor 130, a communicator 140, a display 150, a manipulation inputter 160, and an engine 170.

The operations of the image sensor 110, the memory 120, and the processor 130 are described above with reference to FIG. 1, which will not be further explained below for the sake of brevity.

The communicator 140 may be connected to a terminal (not illustrated) such as mobile device (e.g., a smart phone, a tablet PC, etc.), a PC, a notebook PC, a personal digital assistant (PDA), a digital camera, or the like, and transmit a scan image generated by the image sensor 110 or previously stored in the memory 120 to another terminal. For example, the communicator 140 may be configured to connect the image scanning apparatus 100 to an external device and may not only be connected to a terminal through a local area network (LAN) and an internet network, but also connected through a USB port or wireless communication port (e.g., WiFi 802.11a/b/g/n, near field communication (NFC), Bluetooth, etc.).

The communicator 140 may also be referred to or implemented as a communication device, a transceiver, or the like.

The communicator 140 can receive an original scan image corresponding to the scan data from a different terminal device. In addition, when receiving a request to transmit the original scan image from the different terminal device, the communicator 140 can transmit the original scan image as requested.

The display 150 may display various pieces of information provided from the image scanning apparatus 100. For example, the display 150 may display a user interface window to receive a selection of various functions provided by the image scanning apparatus 100.

The display 150 may be a monitor such as liquid crystal display (LCD), a cathode ray tube (CRT), a light emitting diode (LED), an organic LED (OLED), or the like, and may be implemented as a touch screen that can simultaneously perform a function of the manipulation inputter 160 that will be described later.

Further, the display 150 may display a control menu for performance of functions of the image scanning apparatus 100. Accordingly, a user may input a scan command on the displayed user interface window. In an example, the scan command may be a command to perform the scanning job and may be a command such as scan-to-server, scan-to-digital living network alliance (DLNA), scan-to-cloud, or the like, which transmit a scanning job to a specific server.

Further, when the image scanning apparatus 100 is a multi-function printer (MFP) that includes printing and copying capabilities, the scan command may be a copy command that uses a scan function. Meanwhile, although it is described herein that a scan command is inputted through the manipulation inputter 160, in another implementation, the scan command may be received from a terminal (not illustrated) through the communicator 140.

Further, the display 150 may display the generated scan image and information about the scan image. In an example, the displayed scan image may be the scan image itself or a preview image for the scan image.

The display 150 may display a user interface window for receiving settings related to privacy protection. In addition, the display 150 may display a preview image indicating a masked scan image and may display a user interface window for setting an additional processing method for the masked scan image.

The display 150, when personal information is included in the scan image, may display a notification indicating that personal information is included.

The manipulation inputter 160 may receive from a user a function selection and a control command for the function. In an example, the function may include a print function, a copy function, a scan function, a fax transmission function, or the like. The manipulation inputter 160 may receive an input through the control menu displayed on the display 150.

The manipulation inputter 160 may be implemented as a plurality of buttons, a keyboard, a mouse, or the like, and may be implemented as a touch screen that can simultaneously perform functions of the display 150 as described above.

The manipulation inputter 160 may receive a setting of an option related to personal information protection from a user or receive a setting of additional processing of a currently masked scan image.

In addition, the manipulation inputter 160 may receive an instruction to recover an original image regarding a masked scan image.

The engine 170 prints a scan image. For example, when a copy instruction is received from a user, the engine 170 may print a generated scan image or print a masked scan image.

Although FIGS. 1 and 2 illustrate and describe normal functions of the image scanning apparatus 100, the image scanning apparatus 100 may further include an image processor to perform the print function, a fax trans-receiver to perform the fax trans-receive function, or the like according to functions supported by the image scanning apparatus 100.

As described above, the image scanning apparatus according to an example masks personal information included in a manuscript, so that the protection of the personal information can be addressed. In addition, since scan data including additional information that can recover personal information in the process of generating scan data is generated, an original scan image can be easily used when a user needs the image.

FIG. 3 is a diagram illustrating a form of an image scanning apparatus, such as the image scanning apparatus of FIG. 1, according to an example.

Referring to FIG. 3, the image scanning apparatus 100 may include a first scanning apparatus 101 in a flatbed form, which can scan a document placed on a flat plate, and a second scanning apparatus 102 in an automatic document feeding form, which can successively scan a document placed on an automatic document feeder.

Although it is described herein that the image scanning apparatus 100 includes a plurality of scanning apparatuses, in another implementation, it may include only one of the scanning apparatuses or may include three or more scanning apparatuses.

The first scanning apparatus 101 is a scanning apparatus in a flatbed form, in which a document may be placed on a flat plate and scanned as the image sensor 110 is moved under the flat plate where the document is placed.

The second scanning apparatus 102 is a scanning apparatus in an automatic document feeding form, in which a document may be placed on a document feeder, successively moved to a document transfer path, and scanned by the image sensor 110 positioned on the document transfer path.

As such, when a plurality of manuscripts are scanned using a second scanning device 102, the processor 130 may perform masking processing of the personal information with respect to the scan images of the plurality of manuscripts, and generate one scan data including a plurality of masked scan images and additional information.

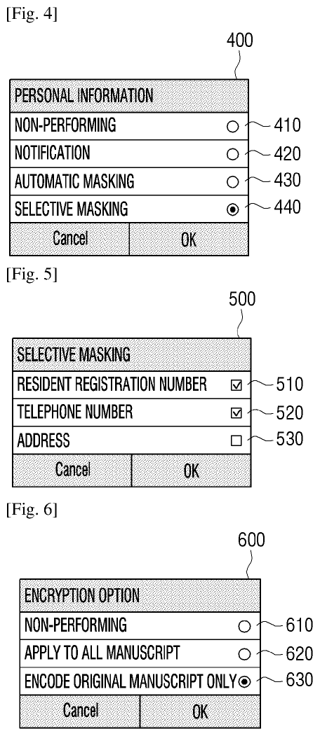

FIGS. 4 to 7 are views illustrating various user interface windows which can be displayed according to examples.

FIG. 4 is an example of a user interface window for receiving a setting of a processing option for personal information.

Referring to FIG. 4, a user interface window 400 includes a non-performing area 410, a notification area 420, an automatic masking area 430, and a selective masking area 440.

The non-performing area 410 provides for selection of an option not to process personal information. If the option is set, the processor 130 may not perform the OCR process for the scanned manuscript and the operation for confirming whether the personal information is included.

The notification area 420 provides for selection of an option to display the personal information to the user when the personal information is included in the manuscript. When the option is set, the processor 130 performs OCR processing on the scanned manuscript and confirms whether personal information is included based on the OCR-processed result. As a result, if the personal information is not included, the processor 130 generates the scan data without further processing. On the other hand, if the personal information is included, the processor may receive confirmation from a user whether to perform the personal information masking process.

The automatic masking area 430 provides for selection of an option for automatically masking personal information when the personal information is included in the manuscript. In the case where the corresponding option is set, if personal information is included in the scanned manuscript, the processor 130 may automatically perform masking processing for the included personal information and generate scan data including the masked scan image.

The selective masking area 440 is similar to the automatic masking area 430 but provides for selection of an option to perform masking processing only on the personal information selected by the user. If the option is selected, a user interface window as shown in FIG. 5 may be displayed.

FIG. 5 is an example of a user interface window which is displayed when the selective masking is selected.

Referring to FIG. 5, the user interface window 500 includes a resident registration number area 510, a telephone number area 520, and an address area 530.

A user may select types of personal information for performing protection for personal information using the user interface window 500.

In the illustrated example, only the resident registration number, the address, and the telephone number are shown as examples of personal information, but various personal information such as a name, an e-mail address, a job title, a passbook number, or the like can be used in implementation. In implementation, a masking method, a masking area (e.g., all or part of personal information) may be separately set for each type of personal information.

FIG. 6 is an example of a user interface window for selecting an encrypting method.

Referring to FIG. 6, a user interface window 600 includes a non-performing area 610, an all manuscript area 620, and an original manuscript area 630.

The non-performing area 610 provides for selection of an option not to perform encrypting for all the original scan image and the mask-processed scan image (i.e., scan data).

The all manuscript area 620 provides for selection of an option to perform encrypting for all the original scan image and the mask-processed scan image.

The original manuscript area 630 provides for selection of an option for performing encrypting and storing the original scan image only.

FIG. 7 is an example of a user interface window for displaying a preview image.

Referring to FIG. 7, a user interface window 700 includes a preview image area 710 and an option area 720.

The preview image area 710 is an area for displaying a preview image of a mask-processed scan image. A user may confirm a state of the mask-processed scan image using the preview image area 710.

The option area 720 is an area for setting an additional processing option for the preview image, including an area to add masking 730, an area to remove masking 740, and an area to recover to an original image 750.

The area to add masking 730 provides for selection of an option for adding masking processing. If the area to add making 730 is selected, the user can additionally set types of personal information or set an area for performing masking.

The area to remove masking 740 provides for selection of an option for removing a part of the masked areas. If the area to remove masking 740 is selected, the user can select the type of personal information that has not been subjected to the masking process or can set the canceled area of the masked area.

The area to recover to an original image 750 provides for selection of an option that does not perform the masking process. If the corresponding area to recover to an original image 750 is selected, a preview image corresponding to the original scan image may be displayed in the preview image area 710.

A print area 770 is an area for receiving an instruction for printing a scan image currently displayed in the preview.

A transmission area 780 is an area for receiving an instruction for transmitting a scan image currently displayed in the preview to a predetermined apparatus.

A storage area 790 is an area for receiving an instruction to store the scan image currently displayed in the preview in the memory.

FIGS. 8 to 10 are views to describe additional information included in scan data according to examples.

FIG. 8 is a view to describe an example of using storage of the original scan image as additional information.

Referring to FIG. 8, when a scan instruction for a transcript including personal information is input, the processor 130 generates a scan image 820 using a signal output from the image sensor 110. The processor 130 may then store the generated scan image 820 in a memory or a predetermined storage. At this time, the processor 130 may encrypt the generated scan image using the personal information identified in a process as described below and store the encrypted scan image in the memory.

The processor 130 may perform an OCR process 810 on the scan image 820 and set an area containing the personal information as a masking area. For example, the processor 130 can confirm the numeric text format of xxxxxx-xxxxxxx as personal information and set a partial area of the detected numeric text as a masking area. As an alternative, the entire area of the numeric text may be set as the masking area.

The processor 130 can identify the area “Gyeonggi-do, Suwon-si, Yeongtong-gu xxx” including the keywords “Gyeonggi-do”, “Suwon-si” and the like corresponding to the address as personal information and set a part of the sensed text as a masking area. As an alternative, the entire text identified by the address may be set as the masking area.

The processor 130 may perform a masking process on the set masking area to generate a masked scan image 830. For example, the processor 130 may perform a black covering over the masked area. As an alternative, various image processing such as mosaic processing or replacing with a preset image may be applied as well as a simple image processing method in which the image is covered with white or covered with the background color of the scan image.

The processor 130 may generate scan data 840 including a stored address 845 of the original scan image 820 and the scan image 830 that has been masked. At this time, the processor 130 may perform encrypting processing using the detected personal information for the storage address included in the scan data and generate scan data using the encrypted storage address.

The generated scan data 840 reduces or prevents loss or theft of personal information because the personal information is masked. In addition, since the storage address at which the original scan image is stored is included as additional information, if the user needs a scan image including personal information, it is possible to easily recover to the original scan image using the additional information.

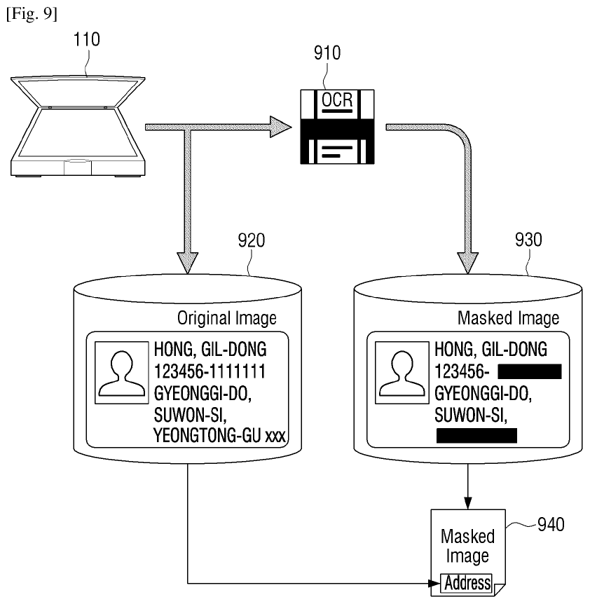

FIG. 9 is a view to describe an example of using an original scan image as additional information.

Referring to FIG. 9, an operation to generate a scan image 920 is the same as in FIG. 8 and thus, the duplicate description will be omitted.

The processor 130 may perform OCR processing 910 on the scan image 920 and may set the area containing the personal information as a masking area. The processor 130 may perform a masking process on the masking area to generate a masked scan image 930.

The processor 130 may generate scan data 940 that includes the original scan image 920 and the masked scan image 930. At this time, the processor 130 may perform an encrypting process using the detected personal information with respect to the original scan image included in the scan data and generate the scan data using the encrypted original scan image.

The generated scan data 940 reduces or prevents loss or theft of personal information because the personal information is masked. In addition, since the original scan image itself is included as additional information, a user can easily use the original scan image included as the additional information.

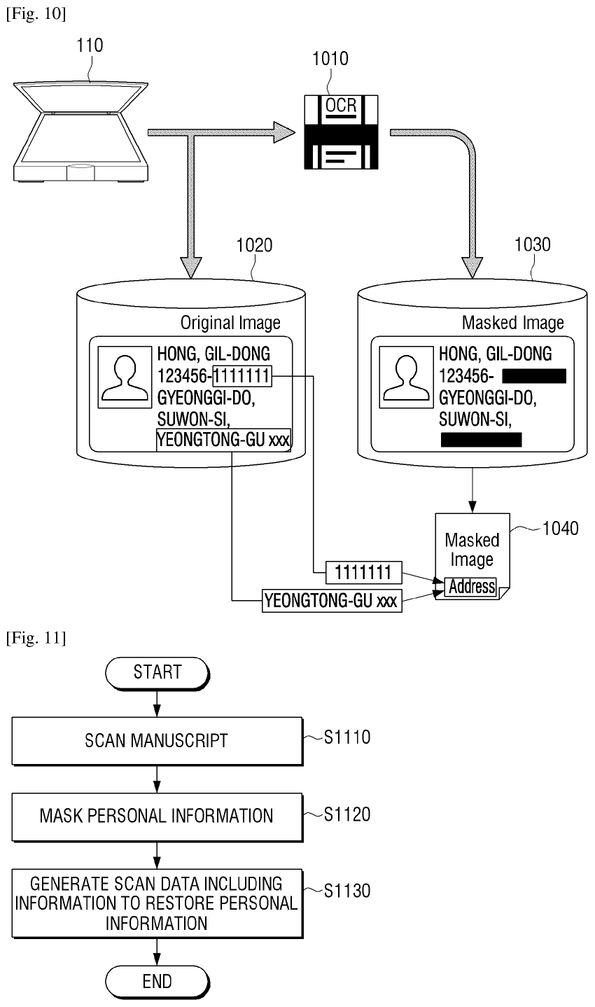

FIG. 10 is a view to describe an example of using a part of an image of the original scan image as additional information.

Referring to FIG. 10, an operation to generate a scan image 1020 is the same as FIG. 8 and will not be described further.

The processor 130 may perform OCR processing 1010 on the scan image 1020 and may set the area containing the personal information as a masking area. The processor 130 may perform a masking process on the set masking area to generate a masked scan image 1030.

The processor 130 extracts some parts of the image corresponding to the masking area in the original scan image 1020. The processor 130 may generate scan data 1040 that includes the extracted image and a masked scan image 1030. At this time, the processor 130 may perform an encrypting process using the detected personal information for the part of image and may generate the scan data using the part of the encrypted image.

The generated scan data 1040 reduces or prevents loss or theft of personal information because personal information is masked. In addition, since a part of an image corresponding to the masked area is included as additional information, if recovering to the original image is needed, the processor 130 can easily recover the original scan image through an operation of replacing the part of image including additional information in the masked area.

Furthermore, since only a part of the original image, not an entire image, is used as the additional information, the size of the generated scan data can be reduced.

FIG. 11 is a flowchart of an image scanning method according to an example.

Referring to FIG. 11, a manuscript is scanned to generate a scan image in operation 51110.

The personal information included in the generated scan image is masked in operation S1120. For example, OCR may be performed on the generated scan image, and an area including personal information is set as a masking area based on the character recognition result. The masking process can be performed on the masking area.

At the time of implementation, the type of the personal information included in the generated scan image can be determined and the masking area on the scan image can be set based on the type of the confirmed personal information.

In operation S1130, scan data which includes additional information for recovering masked personal information and a masked scan image is generated. At this time, the additional information may be encrypted and the scan data including the encrypted additional information and the masked scan image may be generated. Also, the encrypting process may be performed on the scan data. The encrypting process for the additional information and the scan data may be performed by a user or may be a value input during the scan data generation process, and the masked personal information may be used.

The additional information may be a generated scan image, a partial image corresponding to the masked area, text information corresponding to the masked area, a storage address of the generated scan image, or the like.

At the time of implementation, a preview image can be displayed on the masked scan image before generating the scan data. When the scan data is generated, the data can be stored in a predetermined storage, transmitted to a predetermined device, or the like.

An image scanning method according to this example masks personal information included in the manuscript so that the protection of personal information can be further strengthened. In addition, since scan data including additional information that can recover personal information in the process of generating scan data is generated, a user can easily use the original scan image when necessary. The image scanning method as shown in FIG. 11 can be executed on the image scanning apparatus having the configuration of FIG. 1 or FIG. 2, or on an image scanning apparatus or a scanning apparatus having other configurations.

An image scanning method according to the example described above may be implemented as a program and provided to an image scanning apparatus. For example, a program including the image scanning method may be stored and provided in a non-transitory computer readable recording medium.

The non-transitory computer readable recording medium may store data semi-permanently and may be a medium read by a device, rather than the medium storing data temporarily, such as a register, a cache, a memory, or the like. For example, various applications or programs described above may be stored and provided in a non-transitory computer readable recording medium such as a CD, a DVD, a hard disk, a Blu-ray disk, a USB, a memory card, a ROM, or the like.

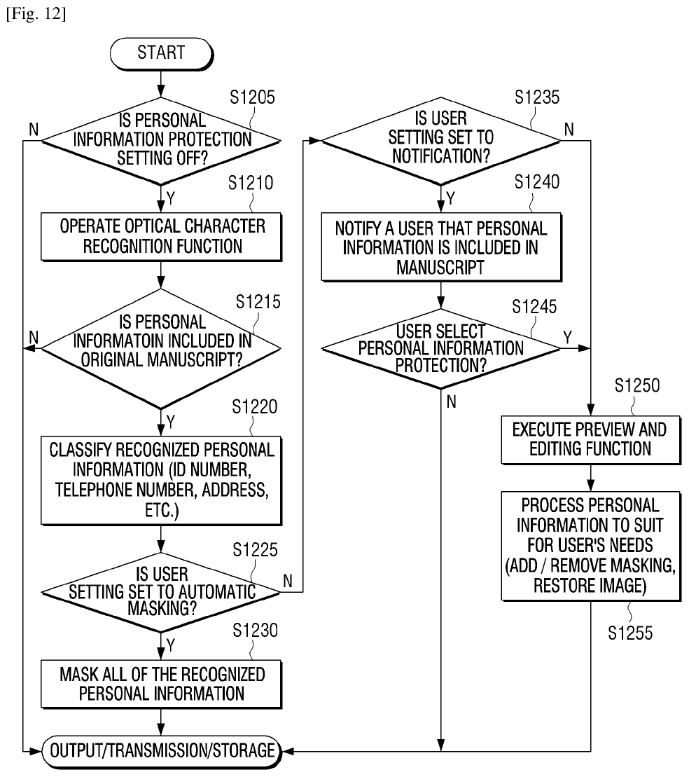

FIG. 12 is a flowchart of an image scanning method using an option setting state according to an example.

Referring to FIG. 12, it is determined whether a personal information protection option is set in operation S1205. If the personal information protection option is not set in operation S1205-N, the original scan image can be directly stored in the memory.

If the personal information protection option is set, and an OCR function is performed on the original scan image in operation S1210, it may be determined whether or not the personal information is included in operation S1215.

If personal information is not included in operation S1215-N, the original scan image can be stored in the memory as it is.

If the personal information is included in operation S1215-Y, the recognized personal information is classified in operation S1220, and it may be determined whether or not the user setting is set to be automatic masking in operation S1225.

If the user setting is set to automatic masking (or selective masking) in operation S1225-Y, all of the recognized personal information (or the personal information preset by the user) is masked in operation S1230, and the masked scan image is stored in a memory.

If the user setting is not automatic masking, that is, if it is a notification in operation S1225-N, it can be determined whether or not the user setting is set to notification in operation S1235.

If the user setting is set to notification in operation S1235-Y, it is notified that the personal information is included in the manuscript in operation S1240. In the meantime, even when the option setting of the user is set to selective masking, the notification processing can be performed without performing the masking processing automatically.

It may be determined whether or not the user selects to require personal information protection in S1245. If the user selects not to require personal information protection in S1245-N, the original scan image can be stored in the memory as it is.

If the user selects to require personal information protection according to the notification in operation S1245-Y, the preview image can be displayed in operation S1250. The masking process is performed according to additional options for the displayed preview image in operation S1255, and the scan image that has been masked according to the user's request can be stored in the memory.

Therefore, an image scanning method according to an example notifies the user that personal information a user fails to recognize is included, so that the leakage of personal information can be reduced or prevented in advance. The image scanning method as shown in FIG. 12 can be executed on an image scanning apparatus having the configuration of FIG. 1 or FIG. 2, or on an image scanning apparatus or a scanning apparatus having other configurations.

Meanwhile, the image scanning method according to the above examples can be implemented by a program and provided to the image scanning apparatus. In particular, a program including a method of image scanning may be provided and stored in a non-transitory computer readable medium.

The foregoing description is merely of examples and is not to be construed as limiting the scope of the invention. The present teaching can be readily applied to other types of apparatuses. Also, the above description is intended to be illustrative and not to limit the scope of the claims.

1. An image scanning apparatus, the image scanning apparatus comprising:
a memory;
an image sensor to scan a manuscript; and
a processor to:
generate a scan image using a signal output from the image sensor,
perform a masking process for personal information included in the generated scan image,
generate scan data including additional information for recovering the masked personal information and the masked scan image, and
store the scan data in the memory.

2. The image scanning apparatus of claim 1, wherein the additional information comprises at least one of the generated scan image, a partial image of the generated scan image corresponding to a masked area, text information corresponding to the masked area, or a storage address of the generated scan image.

3. The image scanning apparatus of claim 1, wherein the processor:
performs encryption for the additional information, and
generates scan data including the encrypted additional information and the masked scan image.

4. The image scanning apparatus of claim 3, wherein the processor encrypts the additional information using the personal information.

5. The image scanning apparatus of claim 1, wherein the processor:
encrypts the scan data using the personal information, and
stores the encrypted scan data in the memory.

6. The image scanning apparatus of claim 1, wherein the processor:
confirms types of personal information included in the generated scan image,
sets a masking area on the scan image based on the confirmed types of personal information, and
performs a masking process for the set masking area.

7. The image scanning apparatus of claim 1, further comprising:
a display to display a preview image which corresponds to the masked scan image.

8. The image scanning apparatus of claim 7, wherein the display displays a user interface window including a first area for displaying the preview image and a second area for selecting an option related to the masking.

9. A method for scanning an image, the method comprising:
generating a scan image;
performing a masking process for personal information included in the generated scan image;
generating scan data including additional information for recovering the masked personal information and the masked scan image; and
storing the scan data.

10. The method of claim 9, wherein the additional information comprises at least one of the generated scan image, a partial image of the generated scan image corresponding to a masked area, text information corresponding to the masked area, or a storage address of the generated scan image.

11. The method of claim 9, wherein the generating of the scan data comprises:
performing encryption for the additional information; and
generating scan data including the encrypted additional information and the masked scan image.

12. The method of claim 11, wherein the generating of the scan data comprises encrypting the additional information using the personal information.

13. The method of claim 9, wherein the generating of the scan data comprises encrypting the scan data using the personal information.

14. The method of claim 9, wherein the masking comprises:
confirming types of personal information included in the generated scan image;
setting a masking area on the scan image based on the confirmed types of personal information; and
performing a masking process for the set masking area.

15. The method of claim 9, further comprising:
displaying a preview image which corresponds to the masked scan image.
